(19) United States
(12) Patent Application Publication
(10) Pub. No.: US 2007/0030253 A1
(43) Pub. Date: Feb. 8, 2007

(54) Touch scroller

(76) Inventors: Cheng-Pu Chu, Tucheng City (TW); Jung-Wen Chang, Lu Chu Hsiang (TW)

Correspondence Address: RABIN & BERDO, P.C., Suite 500, 1101 14 Street, N.W., Washington, DC, 20005, US

(21) Appl. No.: 11/293,304

(22) Filed: Dec. 5, 2005

(30) Foreign Application Priority Data
Aug. 2, 2005 (TW) 94213150

(51) Int. Cl. G09G 5/00

(52) U.S. Cl. 345/173

(57) ABSTRACT

A touch scroller for a display is described. The touch scroller has a touch pad disposed beside the display to scroll the displaying image of the display. The touch pad may be constituted by an L-shaped touch pad and disposed at the corner of the display. The touch scroller can control the displayed image of the display by a user's finger without any additional tool. Accordingly, the touch scroller can be manufactured under lower cost and improve the operability of the display as compared to stylus-operated scrollers.

### RELATED APPLICATIONS

The present application is based on, and claims priority from, Taiwan Application Serial Number 94213150, filed Aug. 2, 2005, the disclosure of which is hereby incorporated by reference herein in its entirety.

### BACKGROUND OF THE INVENTION

1. Field of Invention The invention relates to a touch scroller and, in particular, to a touch scroller for a display in order to scroll the displaying image of the display.

2. Related Art

The conventional notebook computer usually includes a touch pad, a roller, or a trackball that functions as a mouse. Once the computer system is developed into a flat panel computer, with the screen made foldable, devices such as the keyboard and the touch pad are often located at inconvenient positions. The user has to use a specific stylus to write, click or perform scroll operations on the display. If the stylus is lost or if one must hold the flat panel computer with only a single hand, the operation becomes difficult. The cost for making a flat panel computer with a stylus is higher, making it unpopular. When the computer system has a separable display from its host machine, one can fix the host machine at one place and put the display at another. However, if the display is not provided with input devices and one wants to manipulate the display contents on the display, such as by scrolling and clicking, then the user has to operate at the host machine. In this case, either additional wireless input devices are required or the user has to go back and forth between the host machine and the display to double-check each operation. This is extremely inconvenient.

### SUMMARY OF THE INVENTION

An object of the invention is to provide a touch scroller that enables the user to operate the scroll function for accessing the displayed contents by the user's finger without any additional tool.

Another object of the invention is to provide a touch scroller with a lower cost and better convenience than a stylus-operated scroller.

To achieve the above objects, the disclosed touch scroller is used on a display. It comprises at least a touch pad, located at the border of the display to control the scroll function for the displayed contents. The touch pad may be an L-shaped touch pad and disposed at a corner of the display.

In addition, the disclosed touch scroller may contain four touch pads, disposed at the four corners of the display to control the scroll function for the displayed contents.

The touch pads may be L-shaped touch pads. The touch pads may also be disposed on the four sides of the display rather than at the corners. Among the touch pads, two or three adjacent touch pads may be connected into a single touch pad. Alternatively, the four touch pads can be connected into a frame-shaped touch pad around the display.

### BRIEF DESCRIPTION OF THE DRAWINGS

These and other features, aspects and advantages of the invention will become apparent by reference to the following description and accompanying drawings which are given by way of illustration only, and thus are not limitative of the invention, and wherein:

FIG. 1 shows a first embodiment of the disclosed touch scroller;

FIG. 2 shows a second embodiment of the disclosed touch scroller;

FIG. 3 shows a third embodiment of the disclosed touch scroller;

FIG. 4 shows a fourth embodiment of the disclosed touch scroller;

FIG. 5 shows a fifth embodiment of the disclosed touch scroller;

FIG. 6 shows a sixth embodiment of the disclosed touch scroller;

FIG. 7 shows a seventh embodiment of the disclosed touch scroller; and

FIG. 8 shows an eighth embodiment of the disclosed touch scroller.

### DETAILED DESCRIPTION OF THE PREFERRED EMBODIMENTS

The present invention will be apparent from the following detailed description, which proceeds with reference to the accompanying drawings, wherein the same references relate to the same elements.

The vertical, horizontal, upward, downward, left, and right directions referred herein are based upon the accompanying drawings. The word “Quanta” shown in the drawing defines the position of the elements of the invention in relation to the direction of displayed text and imagery.

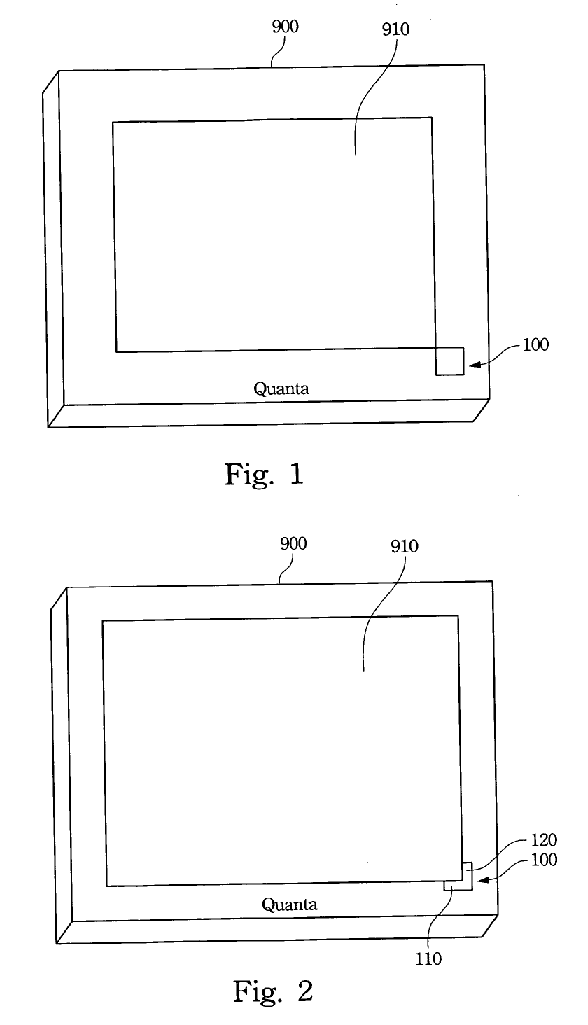

As shown in FIG. 1, the touch scroller disclosed herein includes at least a touch pad 100 disposed at the border of the screen 910 of a display 900. The user utilizes his/her finger to touch the touch pad 100. For example, if the user's finger moves vertically on the touch pad 100, the displayed contents on the screen 910 scroll vertically or the cursor moves in the vertical direction. If the user's finger moves horizontally on the touch pad 100, the displayed contents on the screen 910 scroll horizontally or the cursor moves in the horizontal direction. When the user's finger moves diagonally, comprising vertical and horizontal motions, the displayed content scrolls both vertically and horizontally or the cursor moves in the diagonal direction.

As shown in FIG. 2, the touch pad 100 has an L shape at a corner of the screen 910. The L-shaped touch pad 100 includes a horizontal touch pad 110 and a vertical touch pad 120. When the user touches the horizontal touch pad 110, the displayed contents scroll in the horizontal direction. When the user touches the vertical touch pad 120, the displayed contents scroll in the vertical direction.

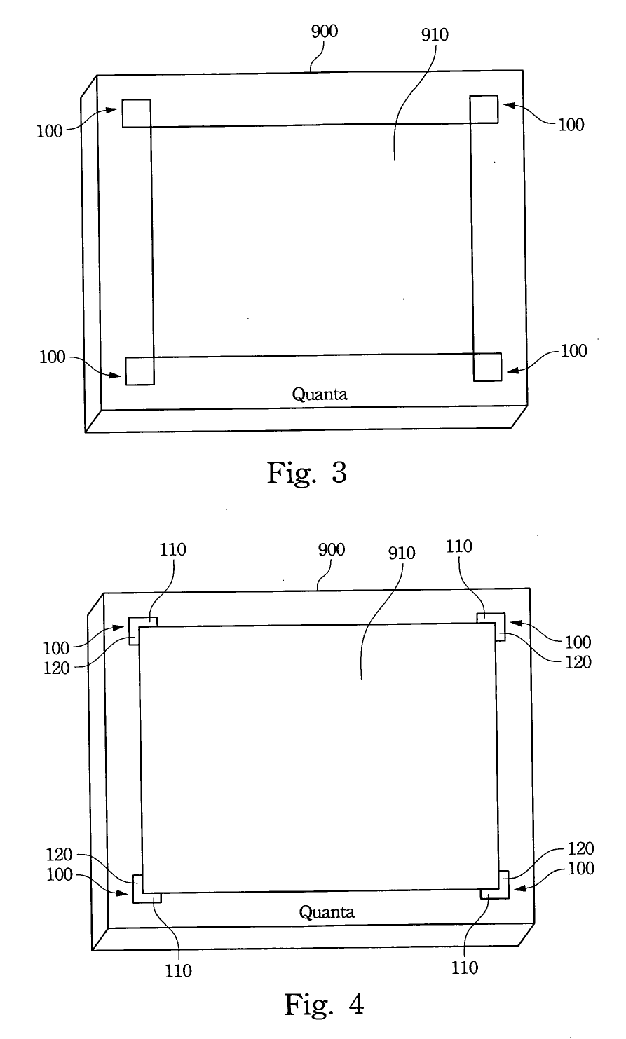

When the display 900 is separated from the computer host machine, the user can hold the display 900 according to the display contents or personal preferences. Therefore, for the convenience of operations, the disclosed touch scroller contains four touch pads 100, as shown in FIG. 3. The touch pads are disposed at the four comers of the screen 910 of the display 900. The user uses his/her fingers to touch any one of the four touch pads 100. For example, if the user uses his/her right hand to hold the display 900 shown in the drawing, he/she can use his/her right thumb to touch the touch pad 100 at the upper right or lower right comer. By vertically moving the right thumb on the touch pad, the displayed contents scroll vertically or the cursor moves in the vertical direction. By horizontally moving the right thumb on the touch pad, the displayed contents scroll horizontally or the cursor moves in the horizontal direction. By diagonally moving the right thumb on the touch pad, the displayed contents scroll both vertically and horizontally or the cursor moves in the diagonal direction.

As shown in FIG. 4, the four touch pads 100 are L-shaped touch pads 100 disposed at the comers of the screen 910. The horizontal touch pad 110 controls the horizontal scroll of the displayed contents, and the vertical touch pad 120controls the vertical scroll of the displayed contents.

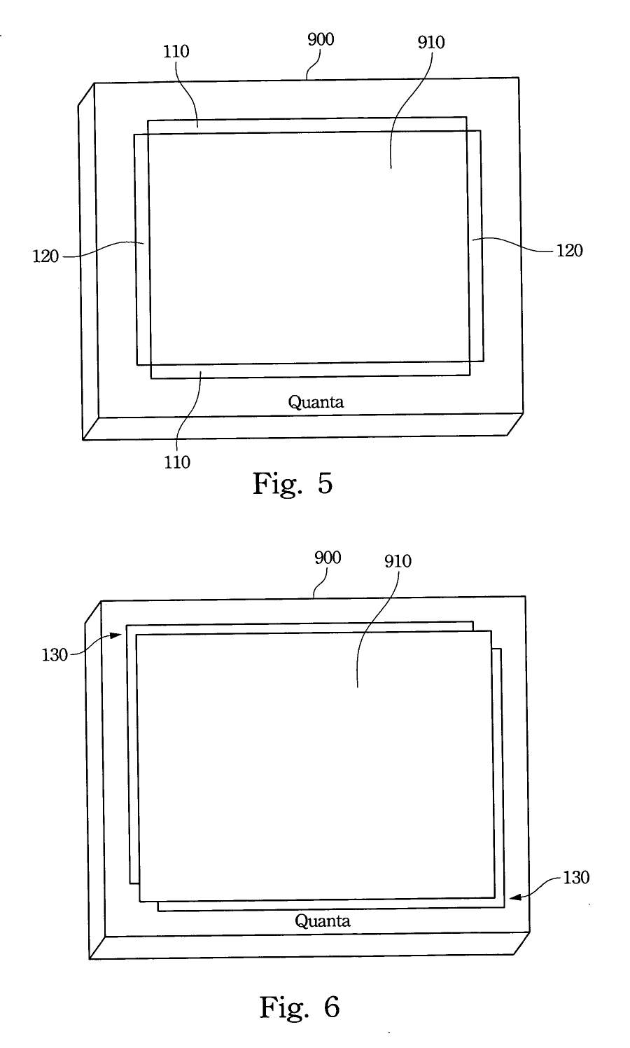

Moreover, as shown in FIG. 5, the touch scroller according to an embodiment of the invention contains four touch pads disposed on the four sides of the screen 910 of the display 900, including two opposite horizontal touch pads 110 and two opposite vertical touch pads 120. The user uses his/her fingers to touch any one of the two horizontal touch pads 110 and any one of the two vertical touch pads 120 to operate the horizontal and vertical scrolling functions for the displayed contents.

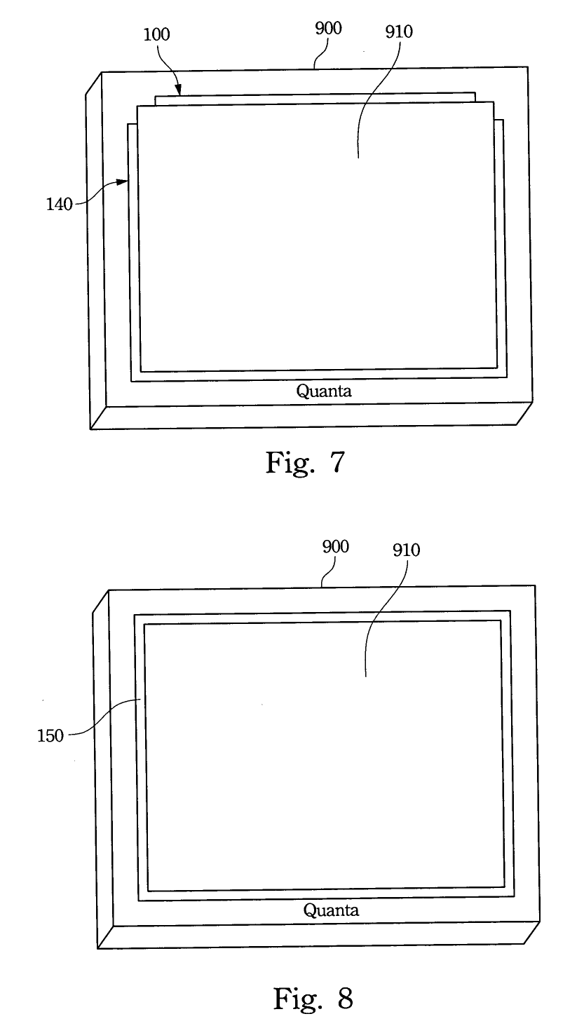

Aside from the independent touch pads disposed at the four corners or on the four sides of the screen, the touch scroller of the invention may have two or three adjacent touch pads connected to form a larger touch pad 130 or 140, as shown in FIGS. 6 and 7. Alternatively, as shown in FIG. 8, the four touch pads can be connected into a frame touch pad 150.

All of the above-mentioned embodiments assume that the display 900 is in its normal state. If the contents on the screen should be rotated clockwise or counterclockwise by 90 degrees or even 180 degrees in order for the user to read, one may still use the corresponding touch pads to control the scrolling function for the displayed contents.

The invention can be modified in various ways within the scope of its technical thoughts. For example, a computer display has been used exclusively to explain the idea of the invention. However, it is not limited only to the computer display. For example, it can be applied to a PDA display. In addition to operating the scrolling function, the touch scroller can be provided with a clicking function as in the conventional touch pads. The touch scroller may be used to change the brightness of the screen. For example, a low-brightness signal is sent when the touch scroller is not in operation, and a high-brightness signal is sent when the touch scroller is in operation. In the drawings, the touch pads are disposed against the screen. In practice, to avoid touching and blemishing the screen, there may be a gap between the touch pads and the screen. The area of the touch pads can be designed according to requirements. Such kinds of embodiments should be construed as part of the invention.

From the above description, one can understand that the invention has the following advantages:
1. One can operate the scrolling function for the displayed contents using fingers without any other tool.
2. The touch scroller can be manufactured at a lower cost and improve the operability of the display compared to stylus-operated scrollers.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A touch scroller for a display, comprising at least a touch pad disposed beside the display to control the scrolling function for displayed contents of the display.

2. The touch scroller of claim 1, wherein the touch pad is an L-shaped touch pad disposed at a comer of the display.

3. A touch scroller for a display, comprising four touch pads disposed at the four comers of the display to control the scrolling function for displayed contents of the display.

4. The touch scroller of claim 3, wherein the touch pads are L-shaped touch pads disposed at the four comers of the display.

5. The touch scroller of claim 3, wherein at least two adjacent touch pads are connected to form a touch pad.

6. The touch scroller of claim 3, wherein at least three adjacent touch pads are connected to form a touch pad.

7. The touch scroller of claim 3, wherein the touch pads surround the screen of the display to form a frame touch pad.

8. A touch scroller for a display, comprising four touch pads disposed on the four sides of the display to control the scrolling function for displayed contents of the display.

9. The touch scroller of claim 8, wherein at least two adjacent touch pads are connected to form a touch pad.

10. The touch scroller of claim 8, wherein at least three adjacent touch pads are connected to form a touch pad.

11. The touch scroller of claim 8, wherein the touch pads surround the screen of the display to form a frame touch pad.
